(19) United States
(12) Patent Application Publication
(10) Pub. No.: US 2012/0021648 A1
(43) Pub. Date: Jan. 26, 2012

(54) Electrical Connector

(76) Inventors: Gang Lee, Shanghai (CN); Chih Hsieh Chang, Taipei (TW); Huibin Li, Shanghai (CN)

(21) Appl. No.: 13/167,503

(22) Filed: Jun. 23, 2011

(30) Foreign Application Priority Data
Jun. 28, 2010 (CN) 201020241386.2

(51) Int. Cl. H01R 13/648

(52) U.S. Cl. 439/607.01

(57) ABSTRACT

The present invention discloses an electrical connector, comprising: an insulative body; a plurality of electrical connection terminals disposed in the insulative body; and a shielding shell substantially enclosing the insulative body. The shielding shell has a pair of solder portions extending outward at each side thereof and a block portion formed between the pair of solder portions.

### CROSS-REFERENCE TO RELATED APPLICATION

This application claims the benefit of Chinese Patent Application No. 201020241386.2 filed on Jun. 28, 2010 in the State Intellectual Property Office of China.

### FIELD OF INVENTION

The present invention relates to an electrical connector, and more particularly, relates to a Universal Serial Bus (USB) connector having a safekeeping structure.

### BACKGROUND

FIG. 1 shows a conventional USB connector. Referring to FIG. 1, the USB connector comprises an insulative body 100, a plurality of electrical connection terminals 200 held in the insulative body 100, and a shielding shell 300 enclosing the insulative body 100.

As shown in FIG. 1, the shielding shell 300 has a pair of solder portions 301, 301 extending outwardly from the out surface of the shielding shell 300 at each side thereof. The pair of solder portions 301, 301 are soldered onto a circuit board (not shown) so as to fix the USB connector onto the circuit board.

Referring again to FIG. 1, in order to improve the manufacturing efficiency and simplicity, an opening 302 is formed between the pair of solder portions 301, 301. However, if the space of the opening 302 is large enough to insert a foreign conductor, such as a metal piece, into the opening 302, the foreign metal conductor may pass through the insulative body 100 and electrically connect isolated electrical elements of the circuit board and the USB connector, causing a short circuit problem or even destroying electrical elements.

Accordingly, the conventional USB connector shown in FIG. 1 has a serious potential problem, for example, upon a metal piece is unintentionally inserted into the USB connector through the opening 302 between the pair of solder portions 301, 301, an electrical system comprising the circuit board and the USB connector will be damaged and fail.

### SUMMARY

The present invention has been made to overcome or alleviate at least one aspect of the above mentioned disadvantages.

Accordingly, it would be advantageous to provide an electrical connector with high safety and high reliability.

According to an aspect of the present invention, there is provided an electrical connector, comprising: an insulative body; a plurality of electrical connection contacts disposed in the insulative body; and a shielding shell substantially enclosing the insulative body. The shielding shell has a pair of solder portions extending outward at each side thereof and a block portion between the pair of solder portions.

### BRIEF DESCRIPTION OF THE DRAWINGS

The invention will be described in greater detail with reference to the accompanying figures of which:

FIG. 1 is an perspective view of a conventional USB connector;

FIG. 2 is an perspective view of a USB connector according to an embodiment of the present invention; and

FIG. 3 is an perspective view of a USB connector according to another embodiment of the present invention.

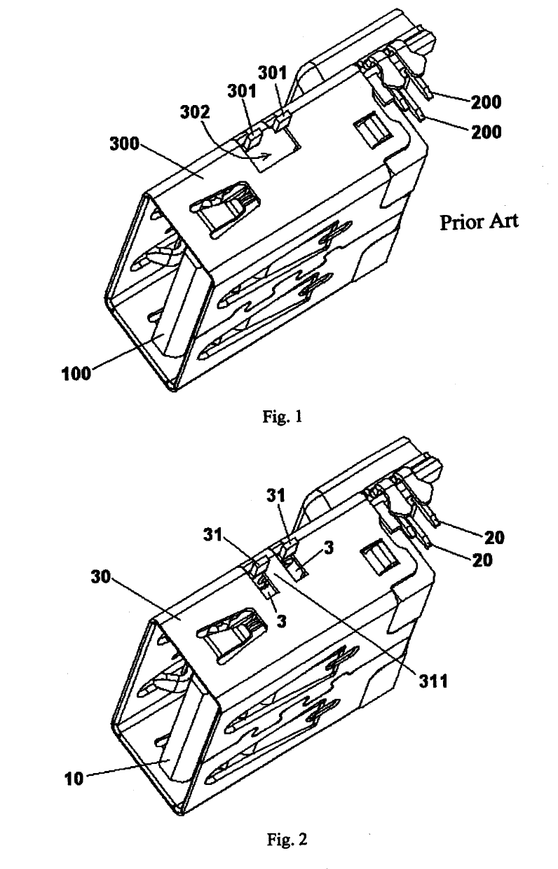

### DETAILED DESCRIPTION OF EMBODIMENTS

The embodiments of the invention will be described hereinafter in detail with reference to the attached drawings, wherein the like reference numerals refer to the like elements. The disclosure may, however, be embodied in many different forms and should not be construed as being limited to the embodiment(s) set forth herein; rather, these embodiments are provided so that the present disclosure will be thorough and complete, and will fully convey the concept of the disclosure to those skilled in the art.

FIG. 2 shows a USB connector according to an embodiment of the present invention. Note that the present invention is not limited to the USB connector, and the USB connector shown in FIG. 2 is used as only an example to expound the electrical connector of the present invention.

Referring to FIG. 2, the USB connector mainly comprises an insulative body 10, a plurality of electrical connection terminals 20 and a shielding shell 30.

As shown in FIG. 2, the plurality of electrical connection terminals 20 are held in the insulative body 10. Each of the electrical connection terminals 20 has a vertical leg to be electrically connected onto a circuit board (not shown) by, for example, welding or insertion. The shielding shell 30 is constructed to enclose the insulative body 10.

In the embodiment shown in FIG. 2, the shielding shell 30 has a pair of solder portions 31, 31 extending outwardly from the outer surface of the shielding shell 30 at each side thereof. The solder portions 31, 31 are soldered onto, the circuit board so as to fix the USB connector onto the circuit board. In this embodiment of the invention, in order to improve the manufacturing convenience, the solder portions 31, 31 are a part of the shielding shell 30, instead of individual portions. For example, the solder portions 31, 31 are integrated with the shielding shell 30 and formed by cutting the shielding shell 30. But the invention is not limited to this. The solder portions 31, 31 may be individual portions soldered to the shielding shell 30.

As shown in FIG. 2, the shielding shell 30 has a block portion 311 formed between the pair of solder portions 31, 31 to prevent any foreign conductor from being inserted into the USB connector through an opening between the pair of solder portions 31, 31, thereby improving the safety of the USB connector in use.

In the embodiment of FIG. 2, the pair of solder portions 31, 31 are shaped as a pair of parallel wings.

Referring again to FIG. 2, the block portion 311 partly covers the opening between the pair of solder portions 31, 31 and leaves two small openings 3 below the pair of solder portions 31, 31. Since the two small openings 3 have a rather small size, thereby it is difficult to insert the foreign conductor therethrough. Furthermore, when the USB connector is soldered onto the circuit board by the solder portions 31, 31, the small openings 3 below the solder portions 31, 31 are just blocked by a side wall of the circuit board having a predetermined thickness. Accordingly, when the USB connector is soldered onto the circuit board, the foreign conductor can not be inserted into the USB connector through the small openings 3 at all.

In the embodiment shown in FIG. 2, the electrical connector is a USB 3.0 connector. But the present invention is not limited to this, the electrical connector may be other types of USB connectors, such as USB 2.0 connector.

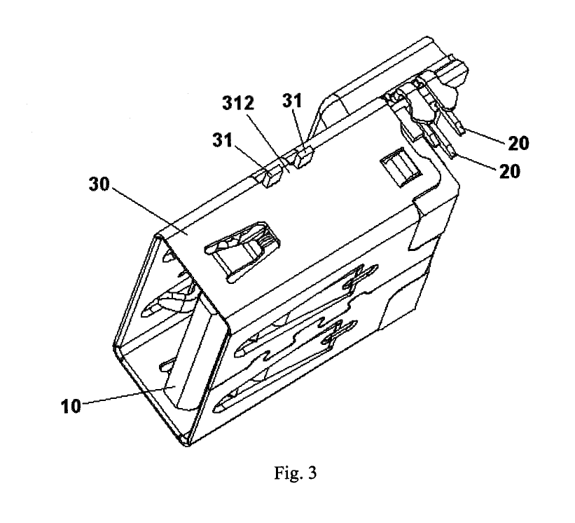

FIG. 3 shows another embodiment of the present invention. The USB connector shown in FIG. 3 is different from the USB connector shown in FIG. 2 in that the block portion 312 completely covers the opening between the pair of solder portions 31, 31. Thereby, before and after being soldered onto the circuit board, the foreign conductor can not be inserted into the USB connector of FIG. 3 because the whole opening between the solder portions 31, 31 is blocked by the block portion 312.

In various embodiments of the present invention, a block portion is provided between the pair of solder portions, any foreign conductor cannot be inserted into the electrical connector through an opening between the pair of solder portions, improving safety of the electrical connector in use.

Although several embodiments have been shown and described, it would be appreciated by those skilled in the art that various changes or modifications may be made in these embodiments without departing from the principles and spirit of the disclosure, the scope of which is defined in the claims and their equivalents. It should be noted that the term “comprising” does not exclude other elements or steps and the “a” or “an” does not exclude a plurality. It should also be noted that reference signs in the claims shall not be construed as limiting the scope of the claims.

What is claimed is:

1. An electrical connector, comprising:
an insulative body;
a plurality of electrical connection terminals disposed in the insulative body; and
a shielding shell substantially enclosing the insulative body,
wherein the shielding shell has a pair of solder portions extending outward at each side thereof and a block portion formed between the pair of solder portions.

2. The electrical connector according to claim 1, wherein the pair of solder portions are shaped as a pair of parallel wings to be soldered onto a circuit board.

3. The electrical connector according to claim 1, wherein the block portion partly covers an opening between the pair of solder portions.

4. The electrical connector according to claim 1, wherein the block portion completely covers an opening between the pair of solder portions.

5. The electrical connector according to claim 1, wherein the electrical connector is a Universal Serial Bus (USB) connector.

6. The electrical connector according to claim 5, wherein the electrical connector is a USB3.0 connector.
